(19) United States
(12) Patent Application Publication
(10) Pub. No.: US 2021/0409548 A1
(43) Pub. Date: Dec. 30, 2021

(54) SYNTHETIC NONLINEAR ACOUSTIC ECHO CANCELLATION SYSTEMS AND METHODS

(71) Applicant: Knowles Electronics, LLC, Itasca, IL (US)

(72) Inventor: Andy Unruh, Itasca, IL (US)

(73) Assignee: Knowles Electronics, LLC, Itasca, IL (US)

(21) Appl. No.: 17/279,484

(22) PCT Filed: Sep. 27, 2019
(86) PCT No.: PCT/US2019/053446

§ 371 Date: Mar. 24, 2021

Related U.S. Application Data
(60) Provisional application No. 62/738,400, filed on Sep. 28, 2018.

(51) Int. Cl. H04M 9/08; H04R 3/02

(52) U.S. Cl. CPC H04M 9/082; H04R 3/02; H04M 9/085

(57) ABSTRACT

A communication system and method is disclosed. The system and method provides for acoustic echo cancellation. For instance, a processor implements a non-linear loudspeaker model to approximate loudspeaker performance. Using the model, a cancellation signal may be generated to ameliorate cross-talk between a loudspeaker and microphone to diminish an echo.

### CROSS REFERENCE TO RELATED APPLICATIONS

The present application claims priority to U.S. Provisional Patent Application No. 62/738,400 filed Sep. 28, 2018, the contents of which are incorporated by reference herein in their entirety.

### TECHNICAL FIELD

This application relates generally to audio processing and more particularly to synthetic nonlinear acoustic echo cancellation systems and methods.

### BACKGROUND

Acoustic echo may occur during a conversation between persons via a communication network. For instance, a far end signal representative of remote sounds (such as those generated by a far end speaker at a remote location) may be carried by the communication network to a near end communication device which may reproduce the remote sounds via a loudspeaker. These reproduced remote sounds may contribute a portion of local sounds making up a local sound environment (for example, in addition to speech of a near end speaker) and captured by the near end communication device for transmission via the communication network. Thus, the far end speaker may hear a delayed reproduction of their own speech and an acoustic “echo” may be said to exist.

### BRIEF DESCRIPTION OF THE DRAWINGS

For a more complete understanding of the disclosure, reference should be made to the following detailed description and accompanying drawings wherein:

FIG. 1 depicts an example audio communication system with a near end communication device and a far end communication device, in accordance with various embodiments;

FIG. 2 illustrates one example implementation of an acoustic echo cancellation aspect of a communication device of an audio communication system, in accordance with various embodiments; and

FIG. 3 illustrates a flow chart depicting an acoustic echo cancellation method, in accordance with various embodiments; and

FIG. 4 illustrates a flow chart depicting a method of modeling a loudspeaker, in accordance with various embodiments.

### SUMMARY

A method of acoustic echo cancellation implemented in a communication device is provided. The communication device may include a controller, a loudspeaker, and a microphone unit. The method may include accessing a loudspeaker model including a plurality of loudspeaker behavior curves, and determining a past loudspeaker position. The method may include selecting a loudspeaker behavior curve from the loudspeaker model, wherein the loudspeaker behavior curve corresponds to a past loudspeaker position approximating the current loudspeaker position. The method may include identifying a first expected loudspeaker behavior responsive to the loudspeaker behavior curve, and generating a loudspeaker cancellation signal responsive to the first expected loudspeaker behavior.

A communication device configured for acoustic echo cancellation is provided. The communication device may include a loudspeaker configured to produce a near end output audio responsive to a far end audio from a far end communication device. The communication device may include a microphone unit configured to generate a raw microphone composition signal including a combination of a near end input audio and a crosstalk audio including at least a portion of the near end output audio. The communication device may also include a controller configured to generate a cancellation signal in response to a non-linear loudspeaker model. Finally, the communication device may include a mixer configured to combine the cancellation signal with the raw microphone composition signal, the combining at least partially attenuating the crosstalk audio, wherein the mixer generates a corrected near end input audio signal comprising the combination of the cancellation signal and the raw microphone composition signal for transmission to the far end communication device.

### DETAILED DESCRIPTION

Skilled artisans will appreciate that elements in the figures are illustrated for simplicity and clarity. It will further be appreciated that certain actions, blocks, and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

According to certain general aspects, the present embodiments are directed to acoustic echo cancellation. As set forth above, acoustic echo may happen during communication via a communication network. A far end signal entering a communication device can be played back by a loudspeaker of the communication device, while a microphone of the communication device may capture both sounds in the nearby environment that make up a near end signal, and also the output of the loudspeaker. The mixture of the near end signal and the output of the loudspeaker can be transmitted back to a far end, so that a listener at the far end whose own speech was output by the loudspeaker now hears a delayed version of this own speech, termed the “echo.”

In various embodiments, a cancellation signal is generated to ameliorate this echo. The cancellation signal may be mixed with a signal including such an echo and the echo may be diminished by the mixing. However, the present applicant recognizes that in practical systems, loudspeakers often exhibit non-linear behavior. As such, the cancellation signal may insufficiently diminish the echo and/or introduce distortions, particularly during periods of non-linear behavior by a loudspeaker. Non-linear behavior in the loudspeaker limits the ability to cancel the echo without degrading the associated signal. These limitations may impede machine voice recognition as well as intelligibility of human communication.

Non-linear behavior in a loudspeaker may include clipping as a moving mass (loudspeaker cone) impinges upon the extreme ends of its range of motion. This may introduce spurious high frequency artifacts, and other anomalies in the reproduced sound. Non-linear behavior may also include a non-linear frequency response. For instance, the frequency response of the loudspeaker may vary such that a sound pressure level (SPL) of a reproduced sound is not linearly related to the input power of the audio signal driving the loudspeaker. Typically, a sound pressure level (SPL) of a reproduced sound of the loud speaker is proportional to the acceleration of the loudspeaker cone. This acceleration may be affected by a variety of factors discussed herein. Thus, one may appreciate that non-linear behavior may include non-linear amplitude domain effects, and also non-linear frequency domain effects.

A loudspeaker may exhibit increasingly non-linear behavior as the loudspeaker cone approaches extreme ends of its range of motion. For instance, as the loudspeaker cone approaches the ends of its range of motion, a variety of forces, such as reaction forces and/or spring forces associated with the position, acceleration, and/or velocity of the loudspeaker cone may contribute to non-linearity. Moreover, a resonant frequency of a loudspeaker may change responsive to a position of the loudspeaker cone along its range of motion. The resonant frequency of the loudspeaker may also change responsive to an amplitude of a driving waveform of the loudspeaker.

Various aspects of a loudspeaker itself may, in response to frequency and time domain aspects of a driving signal of the loudspeaker, contribute to such non-linearity. For instance, a loudspeaker may have a moving mass. The moving mass, such as the loudspeaker cone, may be bounded at the ends of its range of motion, such as by a spring force. A spring force tending to impel the moving mass to a rest position (e.g., centered) may vary depending on the instantaneous displacement of the moving mass from the rest position.

A loudspeaker may exhibit impedance that is a function of the frequency of a signal being provided to the loudspeaker for reproduction. The relationship of impedance to frequency may be dependent on the instantaneous displacement of the moving mass (e.g., loudspeaker cone) from the rest position (e.g., centered). In addition, a resonant frequency of the loudspeaker may further vary in response to the instantaneous displacement of the loudspeaker. These characteristics further may contribute to non-linearity in the behavior of the loudspeaker. Thus, because the loudspeaker is in motion during the reproduction of sounds, and the mechanism by which sound is reproduced is the motion itself, one may appreciate that the electrical and mechanical properties of the loudspeaker are, in various instances, path dependent. Moreover, a back-EMF generated by a moving mass of a loudspeaker further introduces non-linearity and path dependencies. In embodiments wherein the moving mass is a loudspeaker cone, the back EMF may be generated by the voice coil moving through the magnetic flux in the associated gap. In view of the above, non-linearity may be approximated by estimating future/current behavior based on immediately prior path information.

The discussion above is with respect to an audio signal with a “frequency” rather than having many components of many “frequencies.” This is for the sake of brevity. Practically, audio signals may be very complex and polyphonic. Thus, an energy spectral density of an audio signal, from time to time, may introduce very complex non-linear behavior which, due to the effect of the instantaneous displacement of the loudspeaker cone, may be path dependent from one moment to the next.

According to certain aspects of the embodiments, therefore, a stored collection of curves relating loudspeaker behavior to loudspeaker cone position may be exploited so that a loudspeaker behavior may be simulated. Curve fitting methods, such as interpolations and iterative processes, are in many instances less resource intensive when executed by a computer processor than many prior approaches such as efforts to linearize a loudspeaker through computationally intensive mechanisms. Thus, the systems and methods herein improve the operation of a computer processor operating as an echo cancellation component, as well as diminishing power consumption, and enhancing an ability to implement systems and methods herein on embedded systems.

In various instances, a cancellation signal may be produced by a model of the loudspeaker. For example, a processor may electronically model an expected loudspeaker behavior to generate a cancellation signal that can be used to attenuate unwanted reproduced sounds, such as echoes. However, because a loudspeaker may exhibit significant non-linearity, a model may be difficult to parameterize. For instance, the development of a mathematical representation of the loudspeaker may require significant processing resources.

Thus, in various embodiments, and as disclosed herein, a loudspeaker model may be implemented to generate a cancellation signal, wherein the loudspeaker model approximates a loudspeaker behavior in response at least partially to a position of a loudspeaker cone along its range of motion. For instance, a loudspeaker cone may travel along a range of motion during the reproduction of sounds. At any instant, the loudspeaker cone may have an instantaneous displacement along the range of motion and within its terminal bounds. A loudspeaker may exhibit a different transfer function at different instantaneous displacements of the loudspeaker cone along its range of motion. For example, at instantaneous displacements nearer a terminal bound of the range of motion, a loudspeaker may exhibit a transfer function different than at instantaneous displacements of the loudspeaker cone that are farther from a terminal bound of the range of motion. For instance, a loudspeaker cone displaced nearer to a terminal bound of a range of motion may operate to introduce non-linearity into the transfer function different from that when displaced farther from a terminal bound of the range of motion.

In various embodiments, a model is responsive to an instantaneous displacement of a loudspeaker cone. Furthermore, based on a recent instantaneous displacement, a model may approximate a behavior of a loudspeaker at a contemporaneous, but slightly different actual instantaneous displacement. Consequently, a model may be developed based on an instantaneous displacement of a loudspeaker cone at a past time t=t−1, and then may be applied to estimate a loudspeaker behavior at a future instantaneous displacement of the loudspeaker cone at a current time t=t−0. A cancellation signal may be generated responsive to the model and may be mixed with an input signal of a real-world loudspeaker to change the operation of the real-world loudspeaker on-the-fly and thereby ameliorate an echo being generated by the real-world loudspeaker.

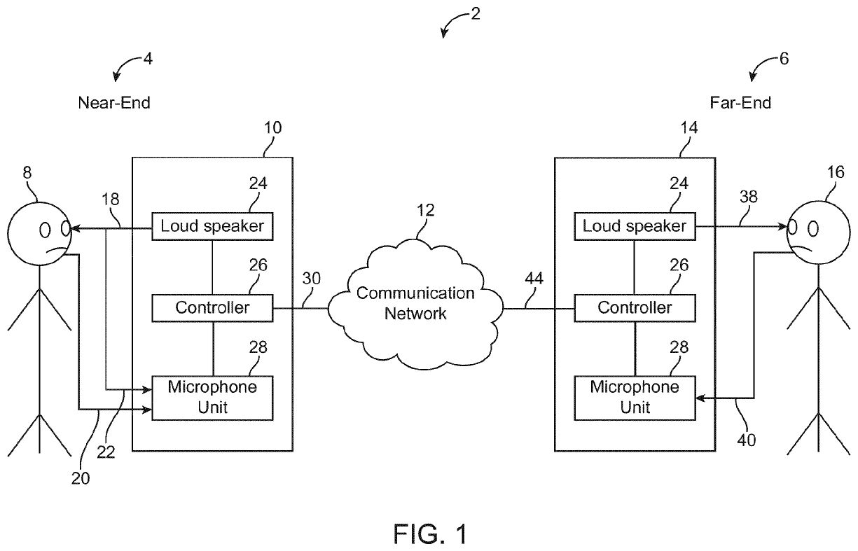

With reference now to FIG. 1, an audio communication system 2 may include a near end communication device 10 and a far end communication device 14. Each communication device 10, 14 may comprise an end point of the audio communication system 2 where audio signals are input and/or output. For example, a near end communication device 10 may be at a near end 4 of an audio communication system 2 and a far end communication device 14 may be a far end 6 of an audio communication system 2. One or more near end users 8 may be located at the near end 4 and one or more far end users 16 may be located at the far end 6. Near end input audio 20 may be generated by activity at the near end 4, for instance, near end speech of the near end user 8. Similarly, far end audio 40 may be generated by activity at the far end 6, for instance, far end speech of the far end user 16. Each communication device 10, 14 may receive the respective audio. For example, the near end communication device 10 may receive the near end input audio 20 and may convey it via a near end link 30 to a communication network 12. The far end communication device 14 may receive the near end input audio 20 from the communication network 12 via a far end link 44 to the communication network 12. Similarly, the far end communication device 14 may receive the far end audio 40 and may convey it via the far end link 44 to a communication network 12. The near end communication device 10 may receive the far end audio 40 from the communication network 12 via a near end link 30.

The near end communication device 10 may reproduce the far end audio 40 as a near end output audio 18. The far end communication device 14 may reproduce the near end input audio 20 as a far end output audio 38.

However, one may appreciate that the near end communication device 10 may also capture the near end output audio 18 in connection with a capturing of near end input audio 20. Such a combination of the reproduced audio at a communication device (output) and the received audio at the communication device (input) causes “echo” to be introduced. More particularly, a portion 22 of near end output audio 18 mixes with the near end input audio 20 and is received by the near end communication device 10. As such, when the mixed near end input audio 18 and portion 22 is reproduced in far end output audio 38, the far end user 16 may perceive a delayed version of his/her own speech that was captured in the far end input audio signal 40, or “echo.”

Directing more specific attention to a communication device 10, 14, a communication device 10, 14 may include one or more loudspeaker, controller, and microphone unit. For example, a near end communication device 10 may include a loudspeaker 24, a controller 26, and a microphone unit 28. Similarly, a far end communication device 14 may also include a loudspeaker 24, a controller 26, and a microphone unit 28. While represented with the same reference numbers and discussed together for convenience, one may appreciate that each aspect of each communication device 10, 14 may take on a variety of configurations, being various embodiments arranged in various ways. For example, aspects of communication device 10 may be represented by the same reference numbers as aspects of communication device 14 but may have different and unique features specific to that communication device.

In various embodiments, a communication device 10, 14 may comprise a loudspeaker 24. A loudspeaker 24 may comprise an audio transducer capable of generating sound waves in response to electrical signals. The loudspeaker 24 may comprise a moving mass aspect, such as a loudspeaker cone.

A communication device 10, 14 may comprise a microphone unit 28. A microphone unit 28 may, in various instances, comprise a single microphone, or may comprise a plurality of microphones such as a microphone array. In various instances, the microphones making up the microphone array are co-located within a single enclosure of the communication device 10, 14.

Finally, and to summarize, a communication device 10, 14 may comprise a controller 26. A controller 26 may comprise a computer processor configured to generate a cancellation signal according to methods disclosed herein. Moreover, the controller 26 may be configured to communicate with the communication network 12 to send and receive audio with other communication devices similarly in communication with the communication network 12. In various embodiments, the controller 26 is a locally disposed processor in an enclosure of the communication device 10, 14. In further embodiments, the controller 26 comprises a remotely located server. In further instances, the controller 26 comprises a distributed cloud computing resource. In various embodiments, the controller 26 includes a non-transitory computer memory including one or more loudspeaker models. The controller 26 may generate a cancellation signal based on a loudspeaker model and mix the cancellation signal with a signal detected by a microphone unit to cancel out a portion that is not desired to be transmitted to the communication network 12. In various instances, this cancellation signal may ameliorate the acoustic echo introduced between a loudspeaker and a microphone.

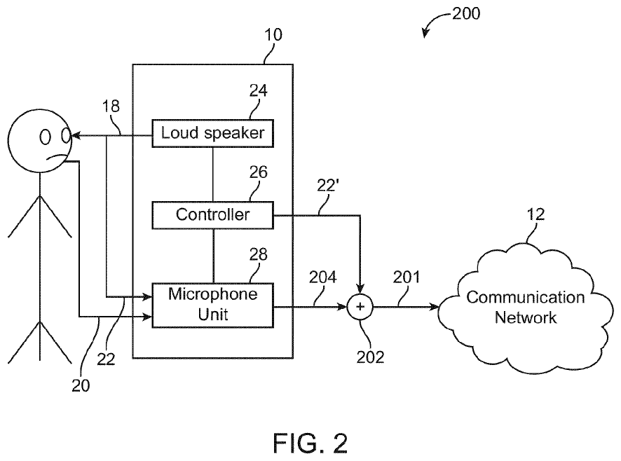

With reference to FIG. 2 in addition to continued reference to FIG. 1, an example cancellation scenario 200 is depicted. A near end communication device 10 is shown and illustrations are with respect to a near end 4 for convenience. However, similar features may be implemented with respect to a far end communication device operating at a far end. In this discussion, only one communication device is depicted for brevity.

A loudspeaker 24 generates near end output audio 18. A near end user 8 hears this audio and also may speak, creating near end input audio 20 which is detected by a microphone unit 28. However, at least a portion 22 of the near end output audio 18 is also received by the microphone unit 28. Thus the microphone generates a raw microphone composite signal 204 comprising a combination of both near end input audio 20 and portion 22 of the near end output audio.

A controller 26 implementing a loudspeaker model generates a loudspeaker cancellation signal 22′. The loudspeaker cancellation signal 22′ approximates the portion 22 of the near end output audio 18. A mixer 202 mixes the loudspeaker cancellation signal 22′ with the raw microphone composite signal 204 (made up of a combination of portion 22 of near end output audio and near end input audio 20). Thus, the loudspeaker cancellation signal 22′ and the portion 22 of near end output audio at least partially cancel, so that a corrected near end audio signal 20′ is produced. The corrected near end audio signal 20′ approximates the near end input audio 20. The corrected near end audio signal is provided to the communication network 12, such as for transmission to a far end 6 so that a far end communication device 14 may reproduce the corrected near end audio signal 20′ for a far end user 16 to hear and understand. In various embodiments, the far end user 16 may be a machine transcription processor configured to generate machine transcriptions, while in further instances; the far end user 16 may be a human listener.

Thus, a communication device 10, 14 is provided. The communication device 10, 14, is configured for acoustic error cancellation and includes a loudspeaker 24. The loudspeaker produces the near end output audio 18 and the portion 22 of the near end output audio 18. The loudspeaker produces near end output audio 18 responsive to a far end audio 40 from a far end communication device (such as a communication device 14). The communication device 10, 14 includes a microphone unit 28 configured to generate a raw microphone composition signal 204. The raw microphone composition signal 204 includes at least portion 22 of the near end output audio 18 as well as a near end input audio 20. The communication device 10, 14 also includes a controller 26. The controller 26 generates a cancellation signal 22′ in response to a non-linear loudspeaker model.

Finally, the communication device includes the mixer 202 configured to combine the cancellation signal 22′ with the raw microphone composition signal 204, wherein the raw microphone composition signal 204 comprises at least a portion 22 of the near end output audio 18. The cancellation signal 22′ at least partially attenuates the at least the portion 22 of the near end output audio 18, generating a corrected near end audio signal 20′ for transmission to the far end communication device (such as a communication device 14). In various embodiments, the controller 26 comprises the mixer 202 as a logical aspect of the controller, such as a digital signal processing routine. In further embodiments, the mixer 202 comprises a discrete component or components of the communication device 10, 14, such as an analog audio mixer. In still further instances, the mixer 202 may be remotely located.

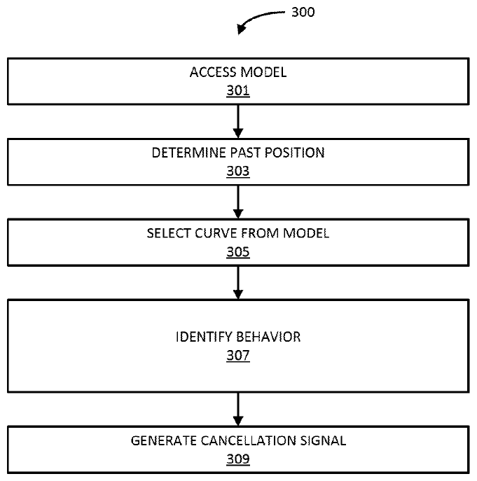

In FIG. 3, a method of generating the loudspeaker cancellation signal 22′ is discussed. The method 300 may comprise a plurality of blocks. A method of acoustic echo cancellation is implemented by a controller of a communication device comprising a loudspeaker and a microphone unit, the method comprising accessing a loudspeaker model comprising a plurality of loudspeaker behavior curves (block 301), determining a loudspeaker position (e.g. a past loudspeaker position approximating the current loudspeaker position) (block 303), selecting a loudspeaker behavior curve from the loudspeaker model, wherein the loudspeaker behavior curve corresponds to the determined loudspeaker position (block 305), identifying a first expected loudspeaker behavior responsive to the selected loudspeaker behavior curve (block 307), and generating a cancellation signal responsive to the first expected loudspeaker behavior (block 309).

For instance, accessing a loudspeaker module comprising a plurality of loudspeaker behavior curves (block 301) may include a controller 26 of a communication device 10, 14 retrieving data representative of a loudspeaker model that maps the loudspeaker frequency response and/or other behavior curve to an instantaneous displacement of a loudspeaker cone.

Determining a loudspeaker position (e.g., past loudspeaker position) may include a controller 26 of a communication device 10, 14 ascertaining based on calculations provided herein, the displacement of the loudspeaker cone along its range of motion at an antecedent moment (block 303).

Selecting a loudspeaker behavior curve corresponding to a past loudspeaker position (block 305) may include selecting by the controller 26 of the communication device 10, 14, a loudspeaker frequency response and/or other behavior curve from the loudspeaker model that is associated with an instantaneous displacement of the loudspeaker cone at the antecedent moment. Since the frequency response/other behavior is a function of instantaneous displacement of the loudspeaker cone, a relatively recent past position is an approximate model of a present/future position, provided the past position is sufficiently proximate. For example, in embodiments, the difference in time between the relatively past position and the present position can be related to the sample rate of the input signal, and is preferably at least two times the sample rate and up to ten times the sample rate. In some embodiments, this translates to between 2 microseconds and 62.5 microseconds. Moreover, iteration may be implemented to further enhance the accuracy of the approximation through repeated approximation of the frequency response/other behavior based on prior approximation(s).

Identifying a first expected loudspeaker behavior responsive to the loudspeaker behavior curve (block 307) may include calculating a first expected loudspeaker behavior such as an expected frequency response/other behavior of the loudspeaker by applying the selected curve to the instantaneous input signal of the loudspeaker at the sample point of the input signal. Stated differently, the first expected loudspeaker behavior includes a time and/or frequency domain representation of the behavior of a loudspeaker cone in simulated response to an instantaneous input signal of the loudspeaker. By applying the selected curve which is associated with an instantaneous displacement of a loudspeaker cone at an antecedent moment, it is possible to approximate how a loudspeaker cone similarly displaced (though slightly different in position) would further respond to an instantaneous input signal.

Finally, generating a cancellation signal responsive to the first expected loudspeaker behavior (block 309) may include creating a signal based on the first expected loudspeaker behavior mapped to an expected echo signal so that the combination of the cancellation signal and the expected echo signal attenuates the expected echo signal. This cancellation signal is mixed with the raw microphone composition signal received from the microphone unit 28 so that the portion of the raw microphone composition signal corresponding to output of the loudspeaker 24 that is fed back into the microphone unit 28 (e.g., the portion 22) is reduced or eliminated.

Having generally discussed a method 300 of acoustic echo cancellation, one example implementation thereof is reproduced below as example MatLab code to effectuate an embodiment of the method 300. For instance, the following example code listing may in various instances implement at least one such method 300 and may include:

```
function[pressure_pa,stats,bl,cm] =
loudspeakerModelLowTouch(mms_g,rms_kgPerSec,cms0_mmPerNewton,bl0_Tm,
rvc_ohms,sd_cm2,magOffset_mm,magMultiplier,magExponent,susOffset_mm,
susMultiplier,susExponent,volume_cm3,fs,inputSignal_volts)
%[pressure_pa,stats,bl,cms] =
runLowFrequencyLoudspeakerModelLowTouch(mms_g,rms_kgPerSec,cms0_mmPe
rNewton,bl0_Tm,rvc_ohms,sd_cm2,magOffset_mm,magMultiplier,magExponen
t,susOffset_mm,susMultiplier,susExponent,volume_cm3,fs,inputsignal_v
olts);
%
%Inputs
% mms_g effective moving mass of loudspeaker in grams
% rms_kgPerSec mechanical resistance in kg/sec
% cms0_mmPerNewton suspension compliance in mm/Newton
% bl0_Tm force factor in Tesla-meters
% rvc_ohms voice coil resistance in ohms
% sd_cm2 diaphragm surface area in square centimeters
% magOffset_mm location of the peak in the force factor, in mm
% magMultiplier scale factor in the force factor vs position
equation
% magExponent Exponent in the force factor vs position equation
% susOffset_mm location of the peak in the compliance, in mm
% susMultiplier scale factor in the suspension compliance vs
position equation
% susExponent Exponent in the suspension compliance vs position
equation
% volume_cm3 Box volume in cubic cm
% fs Sample rate in Hz
% inputSignal_volts input signal in volts. Should be a NX1 vector
%
%Outputs
% pressure_pa Sound pressure in pascals at one meter
% stats.bl.min is the minimum bl used
% stats.bl.max is the maximum bl used
% stats.cm.min is the minimum cms used
% stats.cm.max is the maximum cms used.
% note that cm here has been redefined to give the suspension force
in
% Newtons in the equation Force = x/cm where x is displacement.
%globals
global adjustedCmt
global x1
%fundamental constants
c = 340;
rho = 1.18;
%convert units
mms_kg = mms_g/1000;
cms0_mPerNewton = cms0_mmPerNewton/1000;
magOffset_m = magOffset_mm/1000;
susOffset_m = susOffset_mm/1000;
sd_m2 = sd_cm2/100000;
Volume_m3 = volume_cm3/1e6;
upsampleRatio = 10;
%sig = resample(inputSignal_volts,upsampleRatio,1);
sig = upsample(inputSignal_volts,upsampleRatio);
[b,a] = butter(4,1/upsampleRatio);
sig = filter(b,a,sig);
sig = [0;0;sig]; %this is done because the double differentiation at
the end reduces the signal length by two points.
x_m = zeros(size(sig));
oldX_m = 0;
oldOldX_m = 0;
deltaT_sec = 1/(fs*upsampleRatio);
bl_Tm = bl0_Tm;
bl2_Tm = bl0_Tm*ones(size(sig));
cmb_mPerNewton = volume_m3/(c\hat{ }2*rho*sd_m2\hat{ }2); %box compliance
%Now we are going to modify the calculation for compliance such that
the
%term x/cm would give you the same force at position x as if we were
to
%integrate the cm curve to form a force displacement curve.
x1 = −5:.0001:5; %look at excursions from −5 to + 5 mm to fit the
curve
x1 = x1/1000; %change to meters
cms = cms0_mPerNewton./((cosh(susMultiplier*(x1 −
susOffset_m))).\hat{ }susExponent); %cms vs x
cmt = (cmb_mPerNewton.*cms)./(cmb_mPerNewton + cms); %total
compliance, including enclosure.
kmt = 1./cmt; %the spring constant, which is the reciprocal of the
compliance
force = (x1(2) − x1(1))*cumsum(kmt); %force-displacement curve
without the constant of integration
[yy,ii] = min(abs(x1)); %just finding the point of zero force.
force = force − force(ii); %the actual force-displacement curve.
adjustedCmt = x1./force; %clearly, x1./adjustedCmt will be the
force.
adjustedCmt(ii) = cmt(ii); %just to get rid of the 0/0 error.
options = optimset(‘Display’,‘Off’,‘MaxIter’,10000’,‘TolFun’,1e−
10,‘TolX’,1e−10); %options for the curve fit
x0 = [(cms0_mPerNewton*cmb_mPerNewton)/(cms0_mPerNewton +
cmb_mPerNewton) susMultiplier susOffset_m susExponent ]; %use the
cms values as a starting point except for cm0
x = fminsearch(@cmtModel, x0, options);
cm0_mPerNewton = x(1); %new cm (includes suspension and box
compliance)
susMultiplier = x(2);
susOffset_m = x(3);
susExponent = x(4);
cm_mPerNewton = cm0_mPerNewton;
cm2_mPerNewton = cm0_mPerNewton*ones(size(sig));
for ii = 1:length(sig)
  temp1 = bl_Tm*sig(ii)/rvc_ohms;
  temp2 = bl_Tm\hat{ }2*oldX_m/(rvc_ohms*deltaT_sec);
  temp3 = rms_kgPerSec*oldX_m/deltaT_sec;
  temp4 = 2*mms_kg*oldX_m/deltaT_sec\hat{ }2;
  temp5 = −mms_kg*oldOldX_m/deltaT_sec\hat{ }2;
  temp6 = bl_Tm\hat{ }2/(rvc_ohms*deltaT_sec);
  temp7 = 1/cm_mPerNewton;
  temp8 = rms_kgPerSec/deltaT_sec;
  temp9 = mms_kg/deltaT_sec\hat{ }2;
  x_m(ii) = (temp1 + temp2 + temp3 + temp4 + temp5)/(temp6 + temp7 +
temp8 + temp9);
  oldOldX_m = oldX_m;
  oldX_m = x_m(ii);
  bl2_Tm(ii) = bl0_Tm/((cosh(magMultiplier*(x_m(ii) −
magOffset_m)))\hat{ }magExponent);
  cm2_mPerNewton(ii) = cm0_mPerNewton/((cosh(susMultiplier*(x_m(ii) −
susOffset_m)))\hat{ }susExponent);
  bl_Tm = bl2_Tm(ii);
  cm_mPerNewton = cm2_mPerNewton(ii);
end
stats.bl.min = min(bl2_Tm);
stats.bl.max = max(bl2_Tm);
stats.cm.min = min(cm2_mPerNewton);
stats.cm.max = max(cm2_mPerNewton);
x_m = x_m′;
u_mPerSec = diff(x_m)/deltaT_sec;
a_mPerSec2 = diff(u_mPerSec)/deltaT_sec;
%x_m = resample(x_m,1,upsampleRatio);
%u_mPerSec = resample(u_mPerSec,1,upsampleRatio);
%a_mPerSec2 = resample(a_mPerSec2,1,upsampleRatio);
a_mPerSec2 = filter(b,a,a_mPerSec2);
a_mPerSec2 = downsample(a_mPerSec2,upsampleRatio);
a_mPerSec2 = a_mPerSec2*upsampleRatio;
Pressure_pa = rho*sd_m2*a_mPerSec2/(4*pi); %sound pressure at one
meter
bl = bl2_Tm;
cm = cm2_mPerNewton;
% bl = resample(bl,1,upsampleRatio);
% cm = resample(cm,1,upsampleRatio);
bl = filter(b,a,bl);
bl = downsample(bl,upsampleRatio);
bl = bl*upsampleRatio;
cm = filter(b,a,bl);
cm = downsample(bl,upsampleRatio);
cm = cm*upsampleRatio;
function [err] = cmtModel(x)
global adjustedCmt
global x1
cms0_mPerNewton = x(1);
susMultiplier = x(2);
susOffset_m = x(3);
susExponent = x(4);
cm_modeled =
sqrt(cms0_mPerNewton\hat{ }2)./((cosh(sqrt(susMultiplier\hat{ }2).*(x1 −
susOffset_m))).\hat{ }sqrt(susExponent\hat{ }2));
err = sum(((adjustedCmt cm_modeled)./adjustedCmt).\hat{ }2);
```

Referring more specifically to the code above, the recited code provides for various specific example implementations of aspects of the method 300 discussed above. Reference to specific excerpts of the code are made in parentheses below. While the excerpts recited may not be the complete portion of the code related to the feature being discussed, they are provided to assist with orienting the reader to the exemplary code.

For instance, sampled audio (e.g., inputSignal_volts in the excerpted code) is received. Optionally, the sampled audio may be upsampled (e.g., sig=upsample( . . . )) in the excerpted code). For instance, various subsequent calculations include non-linear operations which may generate outputs with frequency components above those inputted. Thus, by upsampling the sampled audio, performing various steps leading to the generation of a cancellation signal, then downsampling, sound quality may further be improved because aliasing and other associated artifacts and noise are ameliorated.

The above representative code also provides specific details related to one example implementation of the model previously discussed. For instance, a loudspeaker may be modeled as an IIR filter (infinite impulse response). The IIR filter may be a high pass filter. Alternatively, and as illustrated in the representative code herein, to computationally simplify operations and thus improve machine operation, the loudspeaker may be modeled as a second-order low pass filter (e.g., [b, a]=butter ( . . . ), sig=filter(b,a,sig)). Consequently, computationally intensive mathematical integration may be avoided and a digital double differentiation may transform the resulting output to be similar to that of a high pass filter.

Notably, the coefficients of the filter change at each sample point. This is at least in part due to the path dependencies discussed previously. As mentioned, a loudspeaker exhibits different behavior at different points of displacement of the loudspeaker's moving mass (e.g., a loudspeaker cone) relative to a rest point (e.g., centered position) of the moving mass along a range of travel. Consequently, the coefficients of the filter are determined based on prior outputs and change at each sample point. In this manner, the above representative code enabling one example embodiment of the method 300 discussed previously accounts for the mentioned path dependencies.

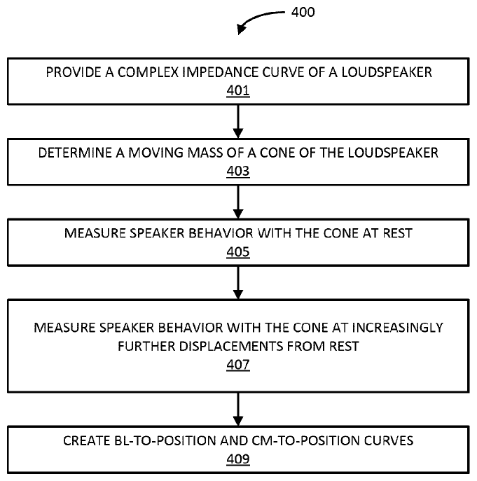

Referring now to the code as well as to FIG. 4, a method 400 of modeling a loudspeaker is disclosed. The method 300 (FIG. 3) begins with accessing a model (block 301), and the method 400 of modeling a loudspeaker provides one way of creating such a model. Notably, if one measures a complex impedance of a loudspeaker as a function of frequency, a curve is produced showing a resonant peak. This curve may be one aspect of a model of the loudspeaker. One may also measure a moving mass (e.g., mms_g in the excerpted code) of a loudspeaker, for instance a mass of a cone of a loudspeaker. As used herein, the mass of the cone of the loudspeaker may be a component of the moving mass, which may also include the effective mass of air being moved, at least a portion of a suspension of a loudspeaker cone, a voice coil former, at least a portion of associated leads, a voice coil mass. Based on the moving mass of the loudspeaker and the curve, further parameters of the loudspeaker may be determined. Thus, a method of creating a model 400 includes providing a complex impedance curve of the loudspeaker as a function of frequency (block 401) and determining a moving mass of a cone of a loudspeaker (block 403).

As mentioned above, parameters that characterize the loudspeaker frequently change as a function of the position of the moving mass of the loudspeaker along its range of motion. One such parameter is a force factor (BL) (e.g., b10_Tm in the excerpted code) of the speaker, which relates the input electrical current (Amperes) to the output force (Newtons) generated by the moving mass (e.g., see mms_g in the excerpted code) of the loudspeaker (e.g., the cone under the influence of the coil as current moving through the voice coil and magnetic flux in a voice coil gap interact). This ratio changes as a function of a position of the moving mass of the loudspeaker, such as the displacement of the loudspeaker cone from a rest position. Generally, the additional output force generated by each additional ampere of current decreases as the moving mass is increasingly displaced further from the rest position.

A further such parameter is a compliance factor (CM) (e.g., cms0_mmPerNewton in the excerpted code). The compliance factor is 1/the spring constant of the moving mass, such as the loudspeaker cone.

One may determine the value of the BL and CM parameters by taking measurements of speaker behavior with the cone at a rest position (block 405) and at increasing displacements from rest (block 407). For instance, a DC offset may be injected so that the loudspeaker moving mass (speaker cone) rests at increasingly further displacements from a rest position, and the BL and CM may be characterized by injecting tones and monitoring behaviors. The measurements are taken at each increasing further displacement. Curve fitting provides a CM-to-position and a BL-to-position curve. Thus, the method further includes creating a CM-to-position and a BL-to-position curve of the loudspeaker cone (block 409).

Based on these curves, the coefficients of the loudspeaker model for each particular distance of cone displacement from a rest position may be determined and pre-stored, creating a loudspeaker model having a plurality of curves to select from among based on a displacement of the loudspeaker cone along its range of motion at an antecedent moment (see FIG. 3, block 303). As mentioned, the loudspeaker model may be accessed in a step 301 of a method 300 discussed with reference to FIG. 3.

As used herein, the singular terms “a,” “an,” and “the” may include plural references unless the context clearly dictates otherwise. Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A method of acoustic echo cancellation comprising:
accessing a model of a loudspeaker, the loudspeaker model comprising a plurality of loudspeaker behavior curves;
determining a past loudspeaker position associated with a past point in time;
selecting a loudspeaker behavior curve from the loudspeaker model, wherein the selected loudspeaker behavior curve corresponds to the determined past loudspeaker position; and
generating a loudspeaker cancellation signal for a near end input audio signal using behavior information in the loudspeaker behavior curve.

2. The method of acoustic echo cancellation according to claim 1, wherein each of the plurality of loudspeaker behavior curves maps a loudspeaker frequency response to an instantaneous loudspeaker position.

3. The method of acoustic echo cancellation according to claim 2, wherein the instantaneous loudspeaker position corresponds to a displacement of a moving mass of the loudspeaker.

4. The method of acoustic echo cancellation according to claim 3, wherein the moving mass comprises a loudspeaker cone.

5. The method of acoustic echo cancellation according to claim 4, wherein the selected loudspeaker behavior comprises an expected frequency response of the loudspeaker cone at the displacement.

6. The method of acoustic echo cancellation according to claim 5, further comprising:
receiving, from a microphone unit, a raw microphone composite signal corresponding to a combination of (i) a first component comprising an output of the loudspeaker detected by the microphone unit and (ii) a second component comprising the near end input audio signal; and
mixing the loudspeaker cancellation signal with the raw microphone composite signal to at least partially cancel the first component comprising the output of the loudspeaker detected by the microphone unit.

7. The method of acoustic echo cancellation according to claim 1, wherein the selected loudspeaker behavior curve approximates behavior for a current loudspeaker position.

8. A method of preparing a device for performing acoustic echo cancellation comprising:
measuring a loudspeaker behavior at a rest position of a moving mass of the loudspeaker;
causing the moving mass to be displaced by a plurality of different displacements from the rest position;
measuring the loudspeaker behavior at the plurality of different displacements from the rest position;
creating a plurality of loudspeaker behavior curves which respectively map the loudspeaker behavior to each of the plurality of different displacements; and
further deriving one or more non-linear parameters of the loudspeaker at each of the plurality of different displacements.

9. The method of claim 8, wherein each of the loudspeaker behavior curves comprises a frequency response of the loudspeaker at the respective displacement.

10. The method of claim 9, wherein the frequency response comprises a complex impedance across a range of frequencies.

11. The method of claim 8, wherein the one or more non-linear parameters includes a force factor of the loudspeaker.

12. The method of claim 8, wherein the one or more non-linear parameters includes a compliance factor of the loudspeaker.

13. The method of claim 8, wherein the moving mass comprises a loudspeaker cone.

14. A communication device configured for acoustic echo cancellation, the communication device comprising:
a loudspeaker configured to produce a near end output audio responsive to a far end audio from a far end communication device;
a microphone unit configured to generate a raw microphone composition signal including a combination of (i) a first component comprising a near end input audio and (ii) a second component comprising at least a portion of the near end output audio;
a controller configured to generate a cancellation signal in response to a non-linear loudspeaker model of the loudspeaker; and
a mixer configured to combine the cancellation signal with the raw microphone composition signal, the combining at least partially attenuating the portion of the near end output audio, the mixer generating a corrected near end input audio signal comprising a combination of (i) the cancellation signal and (ii) the raw microphone composition signal for transmission to the far end communication device.

15. The communication device according to claim 14, wherein the microphone unit comprises a single microphone.

16. The communication device according to claim 14, wherein the microphone unit comprises an array of microphones.

17. The communication device according to claim 16, wherein the controller comprises a distributed cloud computing resource.

18. The communication device according to claim 14, wherein the controller is a locally disposed processor in an enclosure of the communication device.

19. The communication device according to claim 14, wherein the mixer comprises at least one of an analog audio mixer and a digital signal processing routine of the controller.
